(19) United States
(12) Patent Application Publication
(10) Pub. No.: US 2003/0076861 A1
(43) Pub. Date: Apr. 24, 2003

(54) Method and apparatus for packaging laser diodes

(76) Inventors: Kirit S. Dharia, Thousand Oaks, CA (US); Robert Franks, Thousand Oaks, CA (US); Ivair Gontijo, Los Angeles, CA (US); Junpeng Guo, Thousand Oaks, CA (US); Yet-Zen Liu, Westlake Village, CA (US); M.P. Ramachandra Panicker, Camarillo, CA (US); Ruai Yu, Newbury Park, CA (US)

Correspondence Address: KLEIN, O'NEILL & SINGH, 2 PARK PLAZA, SUITE 510, IRVINE, CA, 92614, US

(21) Appl. No.: 10/037,169

(22) Filed: Oct. 19, 2001

(51) Int. Cl. H01S 3/04

(52) U.S. Cl. 372/36

(57) ABSTRACT

A system and apparatus for packaging a laser diode is provided according to the present invention. It includes a solid structure having a first cavity, wherein the first cavity receives a fiber pipe with optical fiber, which is aligned to the laser diode. The solid structure also includes a recess that receives the fiber pipe; and a step for receiving a sealing ring. The solid structure is multi-layered and may be manufactured from ceramic material, beryllium oxide or aluminum nitride. The solid structure includes a second cavity that accommodates a fiber alignment mechanism; a sub-mount on which the laser diode is placed; and/or heat sink used for conducting heat from the laser diode.

### BACKGROUND OF THE INVENTION

1. Field of the Invention

The present invention relates to fiber optics networks and, more particularly to packaging laser diodes.

2. Background

Laser diodes are extensively used in high bandwidth fiber optics networks as transmitters. FIG. 1 shows a top-level block diagram of a typical fiber optics network 100, which includes a transmitter 100A that receives an electrical input (not shown) and converts it to an optical output 100B using a laser diode (not shown). Optical signal 100B is transmitted via optical fiber (not shown) and is received by optical amplifier l00C. Optical amplifier 100C amplifies optical signal 100B and the amplified signal 100D is transmitted to photodetector 100F, via filter 100E.

One important factor that must be considered for packaging laser diodes is the tolerance for aligning the laser diode with the optical fiber. Typically, the tolerance is in sub microns. Also, the alignment must be sturdy enough to withstand prolonged operation under fluctuating thermal and mechanical stresses.

Another important consideration for packaging laser diodes is to ensure proper cooling of the laser diode package (“Package”). Typically, due to continuous operation the laser diode generates heat. This heat must be removed efficiently to avoid overheating. Thermo-electric coolers are typically used to maintain steady temperature of the laser diode.

Yet another important consideration for packaging laser diodes is that the Package must be hermetically sealed so that moisture or other contaminants cannot affect the performance of the laser diode.

A typical laser diode is packaged using the transistor outline (“TO”) format. This format uses glass to metal feed through for maintaining electrical connections. Another conventional packaging technique uses a dual in line package. Both these techniques are limited to a performance of 2.5 GHz and are hence inefficient based on the current and/or future data rate demands, as discussed above.

Yet another conventional package, referred to as the “butterfly package” is shown in FIG. 2. Package 200 includes a pipe 201 through which optical fiber (not shown) enters package 200. Package 200 includes a sealing ring 202 for sealing various components and lead frame 203 for connecting the package to a printed circuit board (not shown). Package 200 includes a laser diode package 204 with lead 205 and thermo-electric cooler 206.

The butterfly package has better performance than the transistor outline and dual in-line package. But the performance of the butterfly package is still limited to only 10 GHZ because it uses thick film technology to define conductive lines, which does not provide effective impedance control, and is not acceptable for the current and/or future high data rate networks.

Another short coming of conventional packages is that optical fiber is placed above a ceramic surface that increases the height of a sub-mount on which a laser diode is placed, which increases the length of the wire bond for connecting the various components on the submount. This increases the inductance and lowers performance. Also, this increases the overall height of the Package and hence requires more space for placement in the fiber optics network.

Therefore, there is a need for a method and apparatus for improving the packaging of laser diodes that allows a laser diode package to be assembled efficiently without comprising performance.

### SUMMARY OF THE INVENTION

There is provided in accordance with one aspect of the present invention a system for packaging a laser diode. The system includes a solid structure having a first cavity, wherein the first cavity receives a fiber pipe with optical fiber, which is aligned to the laser diode. The solid structure also includes a recess that receives the fiber pipe; and a step for receiving a sealing ring. The solid structure is multi-layered and may be manufactured from ceramic material, beryllium oxide or aluminum nitride.

The solid structure includes a second cavity that accommodates a fiber alignment mechanism; a sub-mount on which the laser diode is placed; and/or heat sink used for conducting heat from the laser diode.

In one aspect of the present invention, an apparatus for packaging a laser diode is provided. The apparatus includes a solid structure having a first cavity, wherein the first cavity receives a fiber pipe with optical fiber, which is aligned to the laser diode. The solid structure also includes a recess that receives the fiber pipe; and a step for receiving a sealing ring. The solid structure is multi-layered and may be manufactured from ceramic material, beryllium oxide or aluminum nitride.

The solid structure includes a second cavity that accommodates a fiber alignment mechanism; a sub-mount on which the laser diode is placed; and/or heat sink used for conducting heat from the laser diode.

In another aspect of the present invention, a method for packaging a laser diode is provided. The method includes placing an optical fiber in a fiber pipe; and placing the fiber pipe with the optical fiber on a recess in a solid structure.

In one aspect of the present invention, optical fiber is placed at a lower height than conventional packages, which reduces the overall height of the Package.

In another aspect of the present invention, since optical fiber is placed on the multi-layered ceramic structure it is co-planar with the laser diode and hence shorter wire bond length is required for electrical connections, which reduces induction and improves overall performance.

In yet another aspect, the sub-mount carries heat directly from the laser diode to the base and hence improves laser diode performance.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

FIG. 1 described above, is an illustration of a block diagram of a typical fiber optics network.

FIG. 2 described above, is an illustration of a conventional “butterfly” package.

FIG. 3A shows a cross-sectional view of a laser diode package, according to an aspect of the present invention.

FIG. 3B illustrates a detailed view of a recess in a ceramic structure shown in FIG. 3A.

FIG. 3C illustrates a top-view of the laser diode package shown in FIG. 3A.

FIG. 3D shows a cross-sectional view of the FIG. 3A ceramic structure.

FIG. 4A shows a cross-sectional view of a laser diode package where a sealing ring is replaced by a ceramic structure, according to an aspect of the present invention.

FIG. 4B shows the top-view of the FIG. 4A laser diode package.

FIG. 5A shows a cross-sectional view of a laser diode package with a ceramic wall, according to an aspect of the present invention.

FIG. 5B shows the top-view of the FIG. 5A laser diode package.

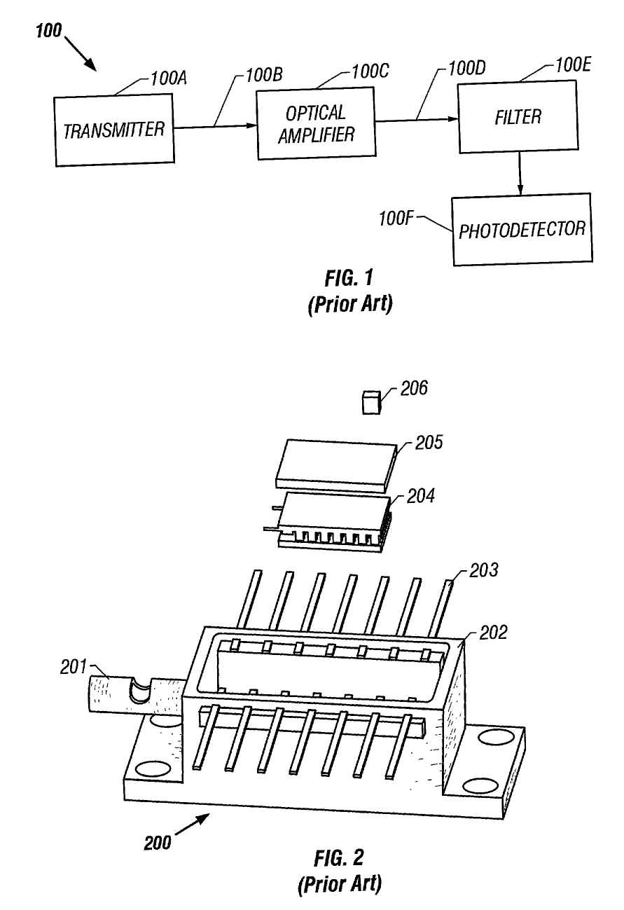

Features appearing in multiple figures with the same reference numeral are the same unless otherwise indicated.

### DETAILED DESCRIPTION OF THE PREFERRED EMBODIMENTS

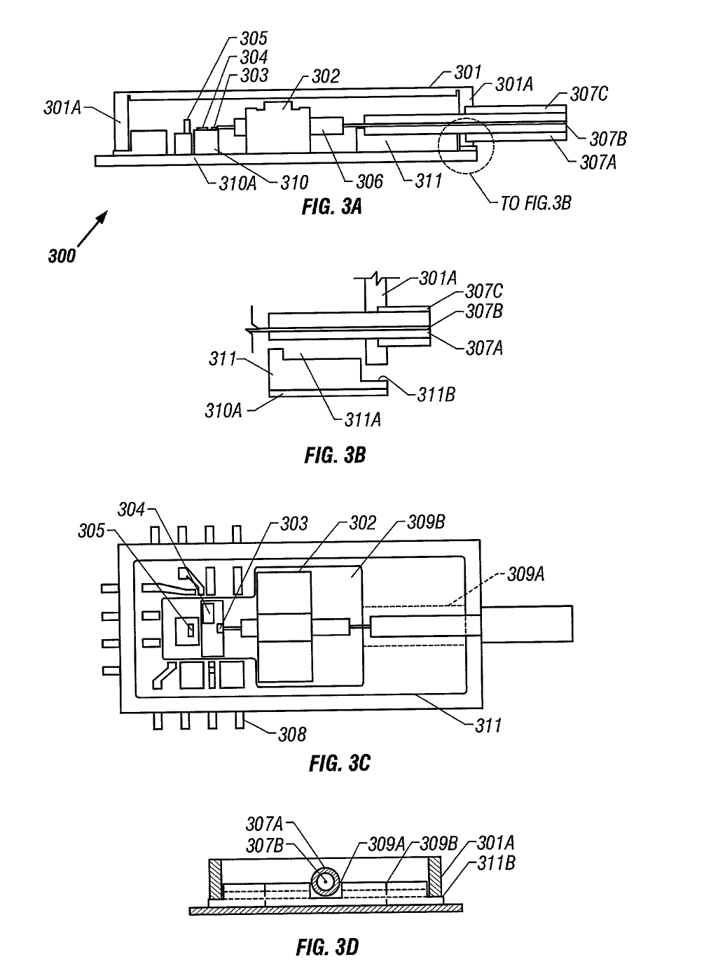

FIG. 3A shows one aspect of the present invention with a surface mount ceramic housing used for packaging a laser diode. The FIG. 3A package includes plural cavities in the ceramic housing such that the overall height of the laser diode package is reduced and the alignment of the fiber with respect to the laser diode is performed efficiently without compromising performance.

Turning now in detail to FIG. 3A is a cross-sectional view of Package 300, according to one aspect of the present invention. Package 300 includes laser diode 303 mounted on a sub-mount 310 with thermistor 304 that monitors the temperature of laser diode 303. Also shown is a tracking pin-diode 305 that tracks the performance of laser diode 303 and is mounted on submount 312. Sub-mount 310 may be manufactured using aluminum nitride (AlxNy) or beryllium oxide (BEO).

Package 300 includes a multi-layered ceramic structure 311. Ceramic structure 311 may use alumina, BEO or AlxNy. Most electrical connections (not shown) may be placed by screen-printing refractory metal paste on thin sheets of alumina (not shown). Various layers in ceramic structure 311 are inter-connected by conducting vias (not shown). Plural cavities may be created in ceramic structure 311.

One such cavity is cavity 309A (shown in top view, FIG. 3C) . Cavity 309A may be used as a recess for placing fiber pipe 307A with optical fiber 307B at an optimum height such that laser diode 303 is co-planar with optical fiber 307B. This allows wire bonds (not shown) connecting the transmission line on the submount 310 to the corresponding transmission line on alumina substrate 311 to be horizontal and short in length, without any loops.

FIG. 3B shows recess 311A that receives fiber pipe 307A, such that optical fiber 307B is at a reduced height than conventional packages. Placing fiber pipe 307A at a lower height reduces the overall package height and hence allows easier placement in the fiber optics network.

Also shown in FIG. 3B is step 311B that receives sealing ring surface 301A. Sealing ring surface 301A is placed on recess 311B and then coupled to ceramic structure 311. One technique to couple sealing ring surface 301A to recess 311B is by brazing. Also, lead 308 and fiber pipe 307A may be brazed to ceramic structure 311. Various brazing alloys, for example, copper-silver-eutectic, aluminum-tin, gold-geranium, and gold-silicon alloys may be used for brazing sealing ring 301A, fiber pipe 307B and leads 312 to ceramic structure 311.

FIG. 3C shows the top view of package 300 with cavity 309A and cavity 309B. Cavity 309B accommodates fiber alignment mechanism 302 with a tube 306 that holds optical fiber 307B in place, and sub mount 310 with laser diode 303 and thermistor 304. Tube 306 may be manufactured from kovar or other material. An additional alumina submount 312 holds the tracking photodiode 305. Sub mount 310 transfers the heat generated by laser diode 303 to base 310A. Typically, base 310A is made of kovar. However, the present invention is not limited to a kovar base 310A.

FIG. 3D shows a cross-sectional view of ceramic structure 311 with fiber pipe 307A placed in cavity 309A with optical fiber 307B. Also, as discussed above sealing ring 301A is placed on step 311B. Also shown in FIG. 3D is cavity 309B that receives the various components of FIGS. 3A and 3B, discussed above.

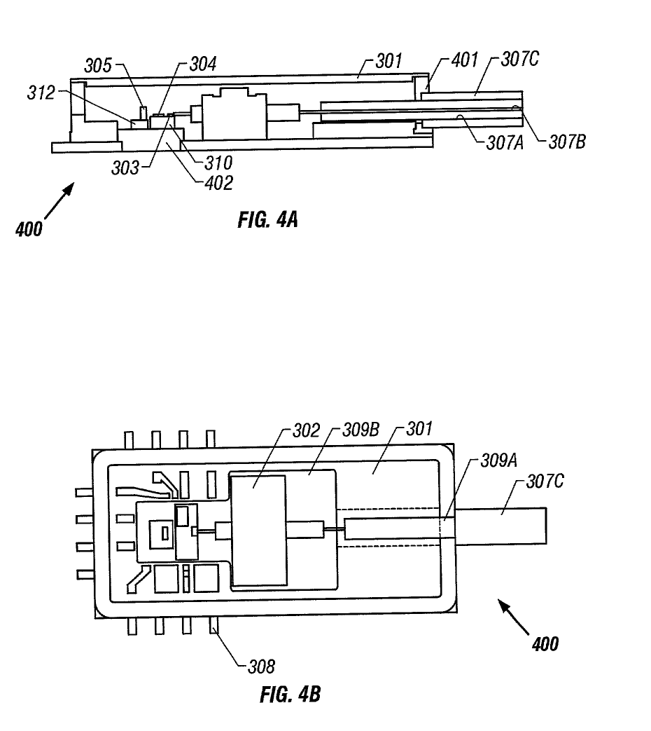

FIG. 4A shows the cross-sectional view of yet another aspect of the present invention. Package 400 includes sub-mount 310 on which laser diode 303 and thermistor 304 are placed. Tracking pin-diode 305 tracks the performance of laser diode 303. Cavity 309A receives fiber pipe 307A with optical fiber 307B.

Package 400 includes a sealing structure 401 that is constructed with material similar to ceramic structure 311. In essence, sealing structure 401 may be used instead of seal ring 301A.

Sealing structure 401 is a solid wall that may be built at the same time ceramic structure 311 is manufactured or laminated using high-temperature co-fired ceramic process or low temperature co-fired ceramic process. Typically sealing structure 401 may be manufactured from alumina.

After the co-fired, ceramic sealing structure 401 is manufactured, its top surface may be metallized using metals such as tungsten and nickel. This allows brazing or soldering of lid 301 to hermetically seal package 400. Alternatively, a thin metal frame may be attached to the top of the metallized ceramic sealing structure 401 by soldering or brazing, to hermetically seal package 400.

Cavity 309B accommodates fiber alignment mechanism 302, and sub-mount 310 with laser diode and thermistor and submount 312 that holds tracking photodiode 305. Cavity 309B also includes a heat sink 402 that is used to dissipate heat generated by laser diode. Heat sink 402 may be constructed from copper-tungsten alloy, or any other metal or alloy with special consideration to thermal expansion match with base 310A.

FIG. 4B shows the top view of package 400 with cavity 309A and cavity 309B with various components discussed with respect to FIG. 4A.

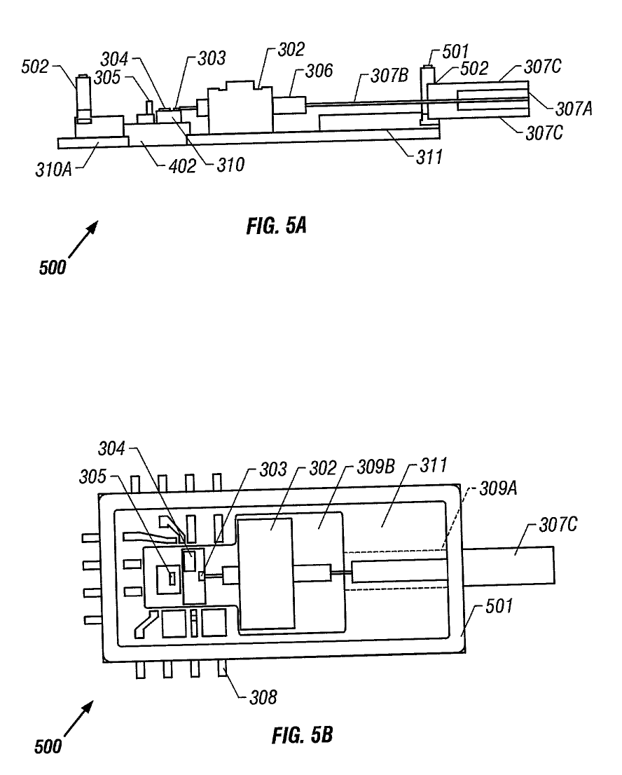

FIG. 5A shows a cross-sectional view of a laser diode package 500 with a co-fired structure 502, which is constructed at the same time as ceramic structure 311. Structure 502 replaces sealing ring 301A (FIG. 3A). Other components of FIG. 5A are discussed above.

Structure 502 includes plural shims 501. Typically, shims 501 are manufactured from kovar. This allows soldering or brazing of a lid onto package 500 to hermetically seal package 500. For example, lid 301, shown in FIG. 4A may be placed on shim 501 to hermetically seal package 500.

In one aspect of the present invention, optical fiber is placed at a lower height than conventional packages, which reduces the overall height of the package.

In another aspect of the present invention, since optical fiber is placed on the multi-layered ceramic structure with cavities of appropriate depths, it is co-planar with the laser diode and hence shorter wire bond length is required for electrical connections, which reduces inductance and improves overall performance.

In yet another aspect, the sub-mount carries heat directly from the laser diode to the base and hence improves laser diode performance.

While the present invention is described above with respect to what is currently considered its preferred embodiments, it is to be understood that the invention is not limited to that described above. To the contrary, the invention is intended to cover various modifications and equivalent arrangements within the spirit and scope of the appended claims.

What is claimed is:

1. A system for packaging a laser diode, comprising:
a solid structure having a first cavity, wherein the first cavity receives a fiber pipe with optical fiber, which is aligned to the laser diode.

2. The system of claim 1, wherein the solid structure includes a recess that receives a sealing ring.

3. The system of claim 2, wherein the solid structure is multi-layered.

4. The system of claim 1, wherein the solid structure is manufactured from multi-layered ceramic material.

5. The system of claim 1, wherein the solid structure includes beryllium oxide.

6. The system of claim 1, wherein the solid structure includes aluminum nitride.

7. The system of claim 2, wherein the recess receives the fiber pipe with the optical fiber.

8. The system of claim 1, wherein the solid structure includes a second cavity that accommodates a fiber alignment mechanism.

9. The system of claim 8, wherein the second cavity accommodates a sub-mount on which the laser diode is placed.

10. An apparatus for packaging a laser diode, comprising:
a solid structure having a first cavity, wherein the first cavity receives a fiber pipe with optical fiber, which is aligned to the laser diode.

11. The apparatus of claim 10, wherein the solid structure includes a recess that receives a sealing ring.

12. The apparatus of claim 11, wherein the solid structure is multi-layered.

13. The apparatus of claim 10, wherein the solid structure is manufactured from multi-layered ceramic material.

14. The apparatus of claim 10, wherein the solid structure includes beryllium oxide.

15. The apparatus of claim 10, wherein the solid structure includes aluminum nitride.

16. The apparatus of claim 11, wherein the recess receives the fiber pipe with the optical fiber.

17. The apparatus of claim 10, wherein the solid structure includes a second cavity that accommodates a fiber alignment mechanism.

18. The apparatus of claim 17, wherein the second cavity accommodates a sub-mount on which the laser diode is placed.

19. A method for packaging a laser diode, comprising:
placing an optical fiber in a fiber pipe; and
placing the fiber pipe with the optical fiber on a recess in a solid structure.

20. The method of claim 19, further comprising:
placing a sealing ring on the recess in the solid structure.

21. The method of claim 20, wherein the solid structure and the sealing ring are manufactured from similar material.

22. The system of claim 8, wherein the second cavity includes a heat sink.

23. The system of claim 3, wherein the solid structure and sealing ring are manufactured from similar material.

24. The apparatus of claim 17, wherein the second cavity includes a heat sink.

25. The system of claim 12, wherein the solid structure and sealing ring are manufactured from similar material.
